(19) United States
(12) Patent Application Publication
(10) Pub. No.: US 2024/0411831 A1
(43) Pub. Date: Dec. 12, 2024

(54) DELEGATION OF PROOF COMPUTATION

(71) Applicant: Provable Inc., Reno, NV (US)

(72) Inventors: Pratyush Mishra, Dublin, CA (US); Howard Wu, Reno, NV (US)

(21) Appl. No.: 18/583,378

(22) Filed: Feb. 21, 2024

Related U.S. Application Data
(60) Provisional application No. 63/472,482, filed on Jun. 12, 2023.

(51) Int. Cl. G06F 17/11

(52) U.S. Cl. CPC G06F 17/11

(57) ABSTRACT

Delegation of proof computation is disclosed, including: receiving, at a first processor, a private input data and a public input data to generate a computationally intensive proof associated with a transaction to be posted to a blockchain; and executing, at the first processor, a first proof computation based at least in part on the private input data and the public input data to generate an intermediate proof state; sending, from the first processor, the intermediate proof state to a second processor, wherein the second processor is configured to execute a second proof computation based at least in part on the intermediate proof state to generate the computationally intensive proof associated with the transaction, wherein it is computationally infeasible for the second processor to derive the private input data from the intermediate proof state.

### CROSS REFERENCE TO OTHER APPLICATIONS

This application claims priority to U.S. Provisional Patent Application No. 63/472,482 entitled DELEGATION OF PROOF COMPUTATION filed Jun. 12, 2023 which is incorporated herein by reference for all purposes.

### BACKGROUND OF THE INVENTION

The generation of proofs that can be used to verify that a requested transaction is in fact authorized by the initiating party can be computationally intensive. Therefore, proof generation is not suitable to be executed at devices that cannot reasonably support such computation in conjunction with other processes that they are expected to efficiently execute. In some conventional systems, the generation of a computational intensive proof can be delegated off of the device of the transaction initiator to another system that has more computational resources. However, in such a conventional type of delegation, any private (e.g., sensitive) data that is input into the transaction (e.g., by the transaction initiator) is also distributed to the one or more entities to which the proof generation has been delegated. Therefore, the delegation of an efficient proof generation along with maintaining the security of any private input data into the transaction is desired.

### BRIEF DESCRIPTION OF THE DRA WINGS

Various embodiments of the invention are disclosed in the following detailed description and the accompanying drawings.

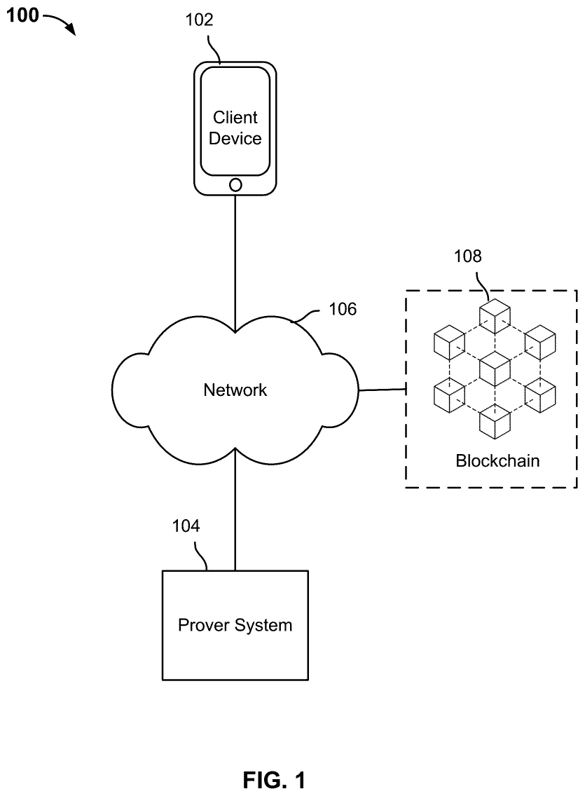

FIG. 1 is a diagram showing an embodiment of a system for delegation of proof delegation.

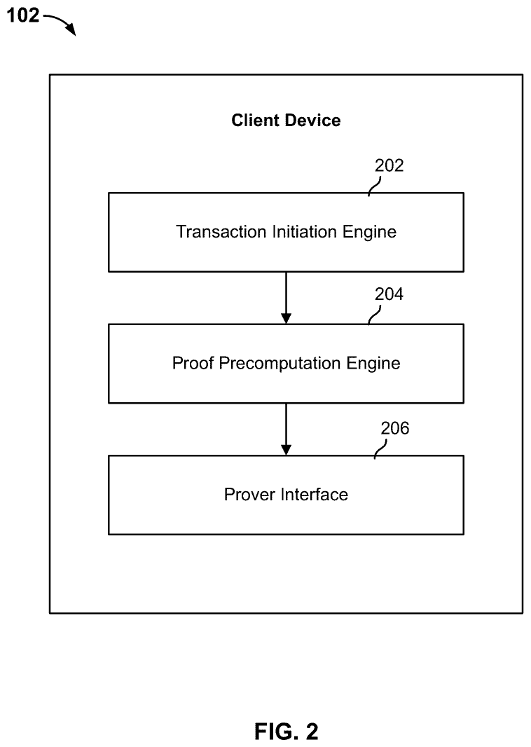

FIG. 2 is a diagram showing an example of a client device for delegating proofs in accordance with some embodiments.

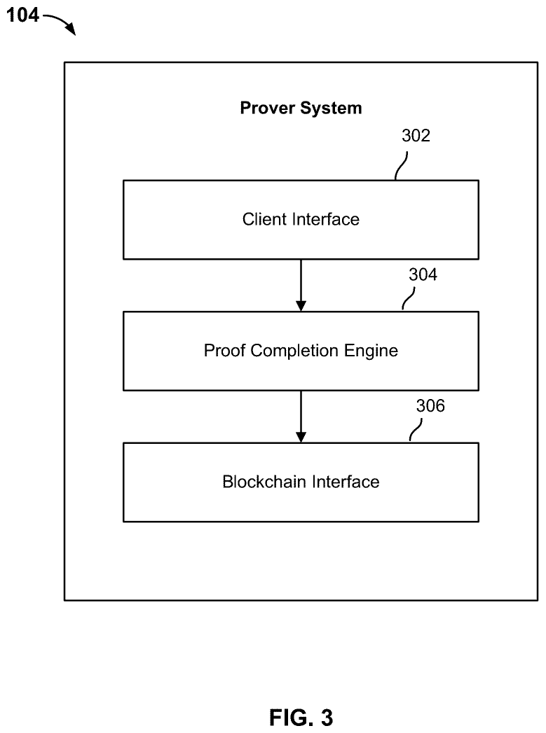

FIG. 3 is a diagram showing an example of a prover system for receiving the delegation of proofs in accordance with some embodiments.

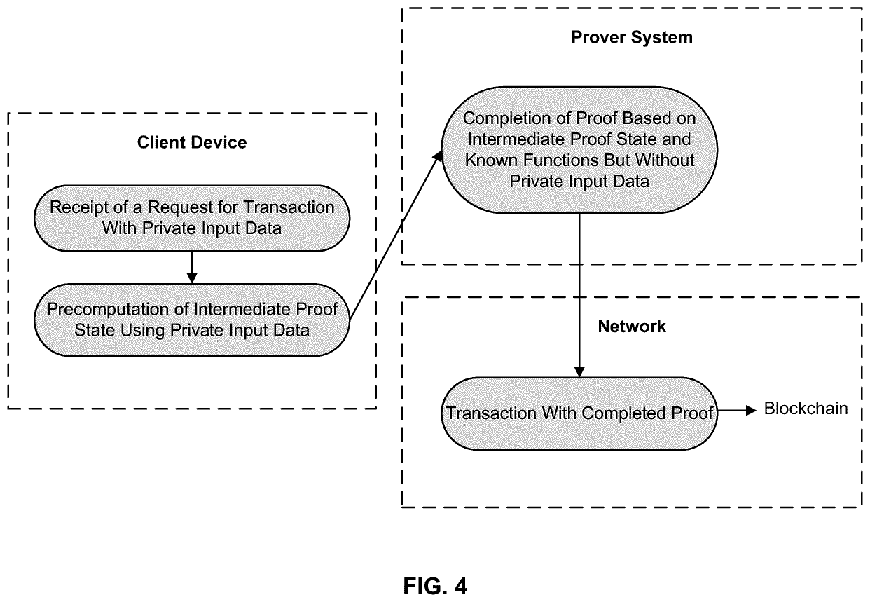

FIG. 4 is a diagram that describes a framework of a client device delegating a portion of the computation of a proof to be associated with a transaction to a single third-party prover in accordance with some embodiments.

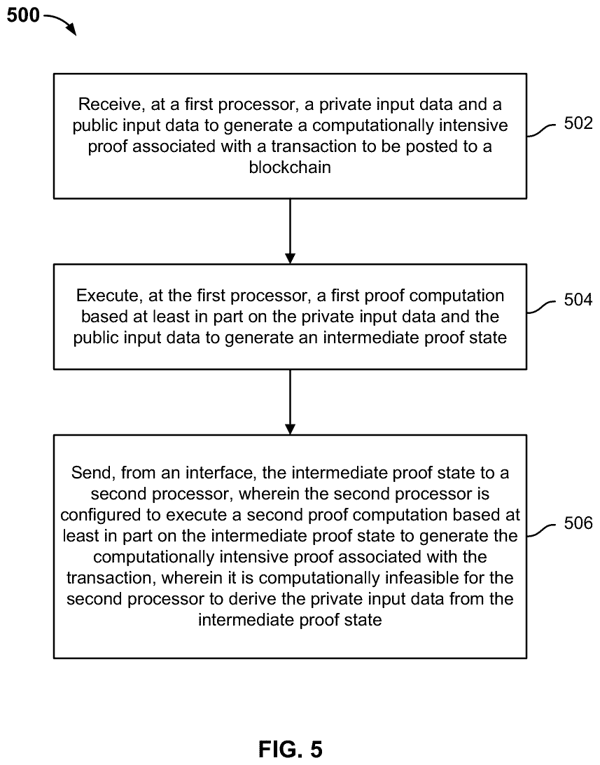

FIG. 5 is a flow diagram showing an embodiment of a process for delegating proof generation.

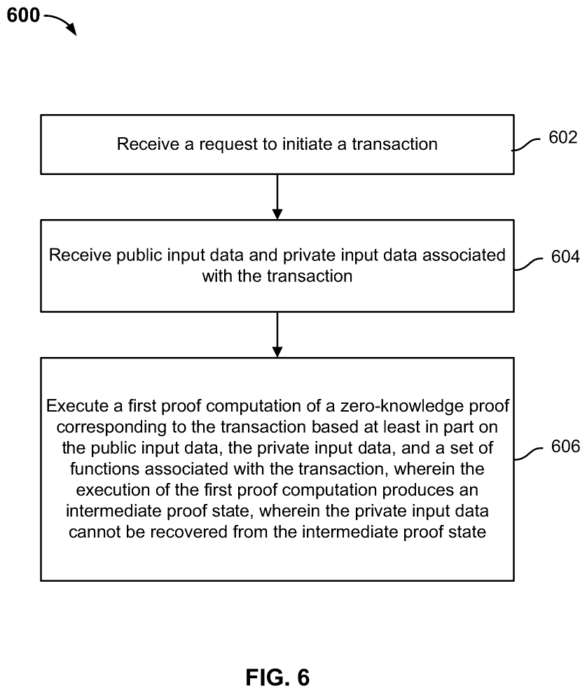

FIG. 6 is a flow diagram showing an example of a process for performing a first proof computation (precomputation) in accordance with some embodiments.

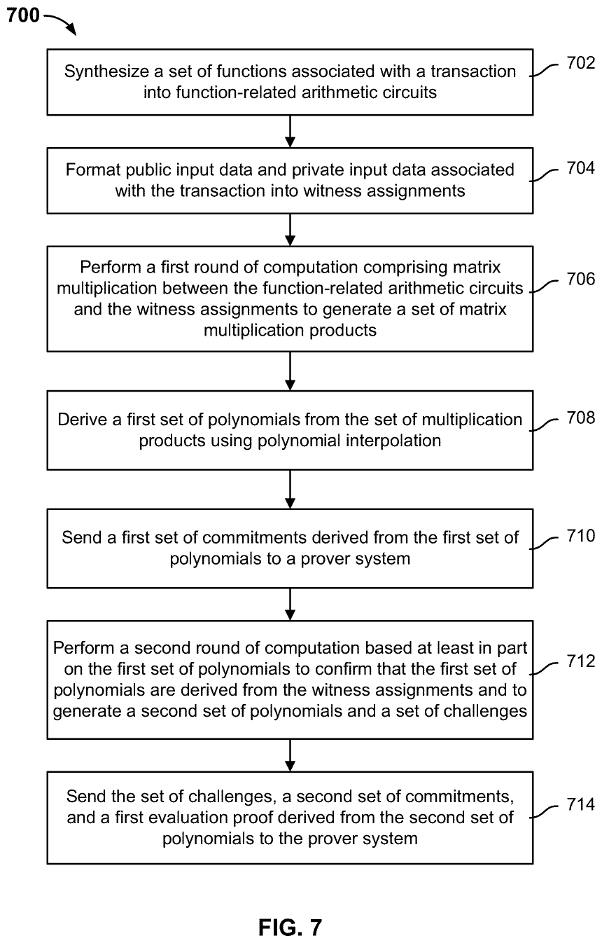

FIG. 7 is a flow diagram showing an example of a process for performing a first proof computation (precomputation) in accordance with some embodiments.

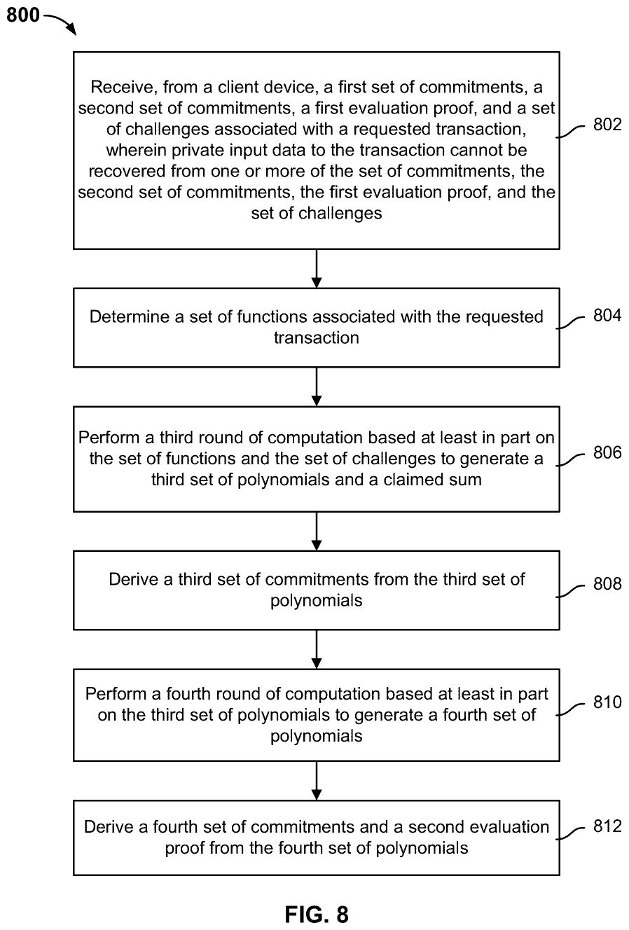

FIG. 8 is a flow diagram showing an example of a process for performing a second proof computation in accordance with some embodiments.

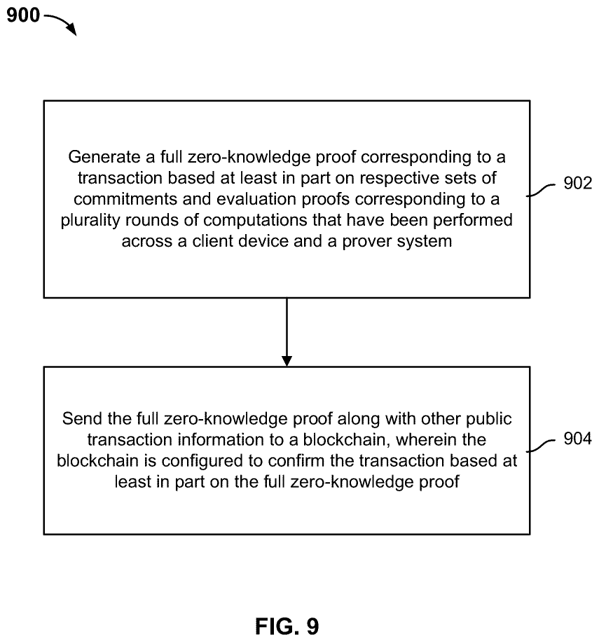

FIG. 9 is a flow diagram showing an example of a process for completing a full proof in accordance with some embodiments.

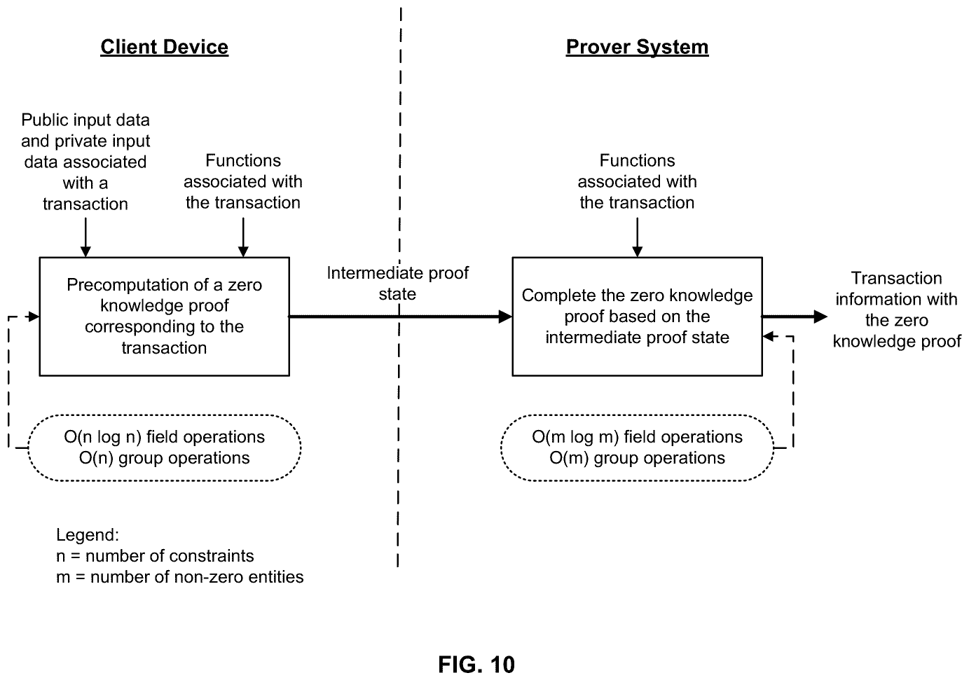

FIG. 10 shows a high-level description of a client device delegating a portion of proof computation to a single prover in accordance with some embodiments.

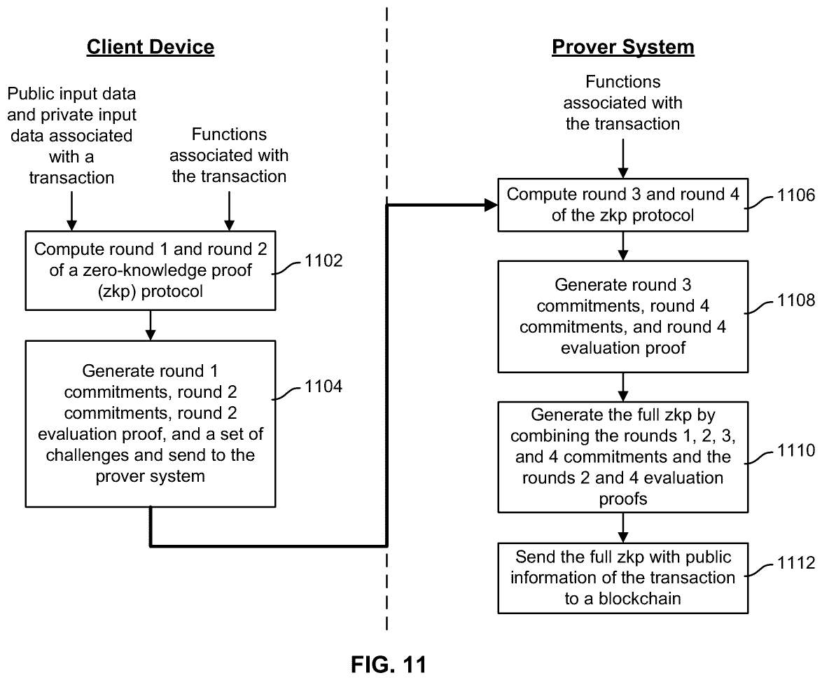

FIG. 11 is a sequence diagram showing an example process of deleting proof generation from a client device to a prover system in accordance with some embodiments.

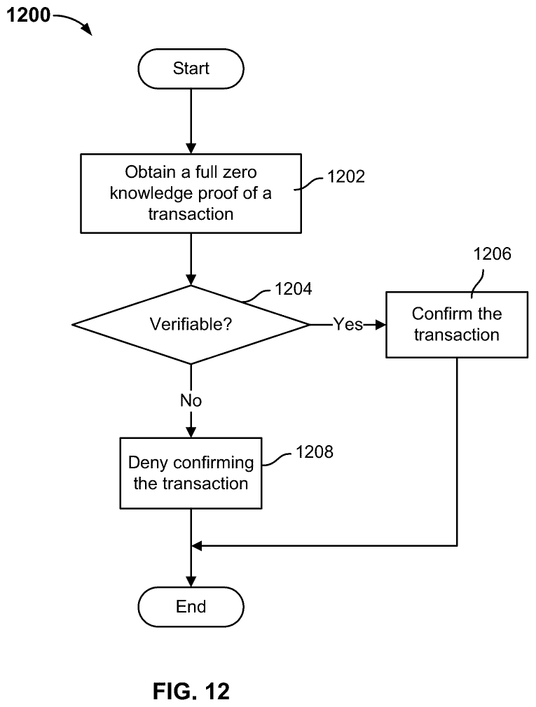

FIG. 12 is a sequence diagram showing an example process of verifying a proof in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of delegation of proof computation are described herein. A private input data and a public input data are received at a first processor to generate a computationally intensive proof associated with a transaction to be posted to a blockchain. For example, the first processor belongs to a client device that is used by a user that has selected to initiate a transaction (e.g., via a software application that is executing at the client device), such as, to transfer tokens to a recipient. In order to enable this transaction to be added to a blockchain, a computation intensive proof that authenticates that the initiator had in fact authorized the transaction is needed be generated and then sent with the transaction information to the blockchain network. In various embodiments, the computation intensive proof is a “zero-knowledge” type of proof. In various embodiments, both public and private data that are input into the transaction are included in the generation of the computation intensive proof. In various embodiments, “private input data” or “private data” refers to sensitive information that is desired to be maintained secure/secret with respect to a prover system, the system to which the generation of the computation intensive proof will be delegated. A first proof computation based at least in part on the private input data and the public input data is executed at the first processor to generate an intermediate proof state. As will be described in further detail below, the “first proof computation” is sometimes referred to as the “precomputation” of the proof. The first proof computation (or “precomputation”) is executed locally to the device at which the transaction was requested using the private and public input data. The intermediate proof state is sent to a second processor and where the second processor is configured to execute a second proof computation based at least in part on the intermediate proof state to generate the completed/full intensive proof associated with the transaction. It is computationally infeasible for the second processor to derive the private input data from the intermediate proof state. After the intermediate proof state is sent to the second processor (belonging to a prover system) to delegate the remainder of the computation of the proof to the second processor, the second processor performs the remainder of the proof computation and constructs the full proof. To the end of achieving security of the private data that is input into the first proof computation/precomputation, the intermediate proof state, which is sent from the first processor to the second processor, has the characteristic that it cannot be used to reverse engineer the private input data. Put another way, a recipient (e.g., the second processor) of the intermediate proof state is not able to recover the private input data into the transaction from the intermediate proof state. After the second processor computes the second proof computation, the second processor can combine at least portions of the intermediate proof state and the results of the second proof computation to generate the completed/full proof. Then, the second processor can send information associated with the transaction along with the generated completed/full proof to a blockchain so that a blockchain node can verify the transaction based on the proof and then add the transaction to the blockchain.

FIG. 1 is a diagram showing an embodiment of a system for delegation of proof delegation. As shown in FIG. 1, system 100 includes client device 102, prover system 104, network 106, and blockchain network 108. Network 106 includes data and/or telecommunications networks.

Client device 102 is configured to execute computer program code associated with a stand-alone software application or a web-browser based application that is configured to manage an account that participates in transactions on blockchain 108. Examples of client device 102 can be a mobile device, a laptop computer, a desktop computer, a tablet device, or any other computing device. A user (not shown) can interact with a user interface associated with the application executing at client device 102 to open a new account. In response to the user input to initiate/request a transaction on blockchain 108, the application executing at client device 102 is configured to execute a process that will result in information related to the transaction being sent to blockchain 108. In a first example, the type of the requested transaction is a deploy transaction that comprises to deploy a new program comprising a set of functions onto blockchain 108. For example, the newly deployed new program/set of functions are to be used in future transactions. In a second example, the type of the requested transaction is an execute transaction that comprises to execute previously deployed programs/functions. For instance, an execute transaction can be used to execute previously deployed programs/functions to effect a transfer of tokens between two accounts on blockchain 108. In various embodiments, in response to a request for an execute transaction, the application executing at client device 102 is configured to obtain user input data and the functions that are relevant to the transaction.

In various embodiments, an execute transaction requires the generation of a computation resource heavy/intensive proof to authenticate the identity of the transaction initiating user. In various embodiments, the type of proof that is to be computed in a “zero-knowledge proof” (which is sometimes referred to as “zkp”), which is a type of proof that proves to a recipient party that a given statement is true (e.g., that the transaction is in fact authorized by the specified account holder) while not revealing the underlying statement itself. The generation of a zero-knowledge proof is often impractical to be completed at the client device 102, at which the execute transaction is initiated, due to the limited amount of computation resources with which client device 102 is equipped. For example, the computation of a zero-knowledge proof at client device 102 may monopolize greater than a desired proportion of computational resources of client device 102 such that client device 102 cannot complete other desired functions. As such, various embodiments described herein enable the computation of a zero-knowledge proof to be partially delegated from the device at which an execute transaction is initiated (e.g., client device 102) to a third-party prover system (e.g., prover system 104), which possesses comparatively greater computational resources. The delegation of a portion of the computation/generation of a zero-knowledge proof as described herein allows client device 102 to start computation/generation of the proof without requiring client device 102 to have enough computational processing resources to complete the proof.

In various embodiments, at least a portion of user input data into an execute transaction may be sensitive data or data that the user otherwise desires to keep private. Examples of private data may be personally identifiable information and/or financial history information. Put another way, this “private” input data to an execute transaction is not desired to be shared with or distributed to another entity other than client device 102 and therefore, the private input user data is not intended to be sent to prover system 104 in the delegation of the zero-knowledge proof. Various embodiments described herein provide for the private input data to be used for the precomputation of the zero-knowledge proof locally at client device 102 but not shared with prover system 104 in the delegation of the generation of the remainder of the proof to prover system 104. As will be described in further detail below, the precomputation of the zero-knowledge proof using the private input data at client device 102 will result an intermediate proof state, which client device 102 will send to prover system 104 over network 105 for prover system 104 to use to complete the full zero-knowledge proof. However, despite having been derived in part from the private input data, the intermediate proof state cannot be used to recover the private input data. In this way, prover system 104 then can use the intermediate proof state to complete the generation of the full zero-knowledge proof without ever learning of the private input data to the execute transaction.

After completion of the generation of the zero-knowledge proof, prover system 104 is configured to send the proof along with other (public) information related to the execute transaction to blockchain 108. In some embodiments, after prover system 104 completes the full proof, prover system 104 can send the full proof to client device 102 for client device 102 to send the proof along with the public information related to the execute transaction to blockchain 108. The node(s) of the blockchain will verify the received zero-knowledge proof before adding the (e.g., output records of the) transaction to the ledger.

As will be described in herein, in various embodiments, sensitive, private input user data that is locally stored at a client device can be used to compute a first portion (which is sometimes referred to as the “precomputation”) of a proof (e.g., a zero-knowledge proof) at a client device (e.g., a device with comparatively less computational resources than a prover system). In some embodiments, the proof is to be associated with a transaction that is ultimately to be recorded at a blockchain. In various embodiments, the proof protocol is selected such that the precomputation of the first portion of the proof that is performed at the client device is less computationally intensive than the remaining, second portion of the proof that is to be performed by the prover system. The remaining, second portion of the proof can then be delegated from the client device to the prover system by providing at least the function(s) that were used to compute the first portion of the proof at the client device and, potentially, at least a part of the first portion of the proof. Advantageously, the client device does not need to pass to the prover system any of the sensitive, private input user data that was used to compute the first portion of the proof. The first portion of the proof and the remaining, second portion of the proof can be combined (e.g., by the prover) to construct the full proof. The entity that generates the full proof can then send the full proof to a blockchain network to associate the full proof with the transaction. The blockchain network can confirm the transaction by verifying the full proof.

FIG. 2 is a diagram showing an example of a client device for delegating proofs in accordance with some embodiments. In some embodiments, client device 102 of FIG. 1 may be implemented using the example client device of FIG. 2. As shown in FIG. 2, the client device includes transaction initiation engine 202, proof precomputation engine 204, and prover interface 206. Each of transaction initiation engine 202, proof precomputation engine 204, and prover interface 206 can be implemented using software and/or hardware (e.g., a processor, a communication interface, a memory).

Transaction initiation engine 202 is configured to receive requests for transactions to be posted on a blockchain. To initiate a transaction that is to be confirmed by a blockchain, the user of an account will input, into a user interface of the application executing at the client device, parameters (input data) associated with the transaction. For example, if the transaction were an execute transaction that related to the spending tokens associated with the account, then parameters associated with that transaction may include identifying information associated with one or more confirmed records at the blockchain network that document what the new account possesses. These confirmed records will be included by the application into the transaction as one or more input records. Furthermore, in this example, the user input parameters would also include at least the amount of tokens that the user wishes to send to a recipient party and at least one output record that is to be confirmed by the blockchain network that specifies the account address of the recipient party, a program (a set of functions) to be executed, and the amount of tokens to be sent to the recipient party, which will be included by the application into the transaction as an output record. In various embodiments, while certain parameters that are input by the user for a transaction are considered “public” or permitted to be shared with another entity, such as a prover system, certain parameters that are input by the user for the transaction are considered “private” or restricted from being shared with another entity. In some embodiments, which parameters/input data are private or public can be designated based on the application/type of execute transaction. Specific examples of public input data may include the program/functions to be executed, the serial number of the input records, identifying information of the blockchain, the credit score of the user of the sender account. Specific examples of private input data may include financial history of the sender account, personally identifiable information of the user of the sender account, the private account key of the sender account, and the account address of the sender account. For example, whether a user input parameter is public or private can also be determined based on predetermined rules (e.g., if the amount of tokens to be transferred in a transaction is greater than a predetermined amount, then the token amount is designated to be a private user input in that transaction).

Proof precomputation engine 204 is configured to perform a precomputation (a first portion) of a zero-knowledge proof corresponding to the initiated/executed execute transaction based on the parameters (public and private input data) of the transaction. In this context, the “zero-knowledge proof” verifies that the transaction was initiated by the holder/user of the account that had initiated the transaction without revealing to a verifier (e.g., the nodes of a blockchain network) the private input data. A zero-knowledge proof protocol that has the property of being able to divide proof generation into a first, private portion that requires input data (including the private input data) into the execute transaction and a second, public portion that does not require the private input data directly is used to generate the proof in various embodiments described herein. One example of a zero-knowledge proof protocol with this property is the Marlin protocol. As such, proof precomputation engine 204 is configured to perform the first portion (precomputation) of the zero-knowledge proof based on the public and private input data to the transaction. As will be described in detail further below, in some embodiments, performing the first portion (precomputation) of the zero-knowledge proof based on the public and private input data to the transaction comprises computing two sequential rounds of computations (the first and second rounds), whereby the transaction's private and public input data is input into the first round and the second round receives as input the output from the first round. A portion of the outputs from both the first and second rounds of proof precomputation by proof precomputation engine 204 is sent by prover interface 206 to a prover system over a network. This portion of the outputs from both the first and second rounds of proof precomputation is sometimes referred to as an “intermediate proof state.” In various embodiments, the intermediate proof state comprises data that is specific to the transaction but cannot be used to recover the private input data into the transaction.

Proof precomputation engine 204 is configured to send a proof delegation request to a prover system along with the intermediate proof state of the transaction's proof that the prover system is requested to complete. The recipient prover system is then configured to complete the second/remaining portion of the zero-knowledge proof based on the intermediate proof state. For example, a proof delegation request may include public information related to the transaction and identifying information of the blockchain to which the transaction is to be posted.

FIG. 3 is a diagram showing an example of a prover system for receiving the delegation of proofs in accordance with some embodiments. In some embodiments, prover system 104 of FIG. 1 may be implemented using the example prover system of FIG. 3. As shown in FIG. 3, the prover system comprises client interface 302, proof completion engine 304, and blockchain interface 306. Each of client interface 302, proof completion engine 304, and blockchain interface 306 can be implemented using software and/or hardware (e.g., a processor, a communication interface, a memory).

Client interface 302 is configured to receive requests for proof delegation and corresponding intermediate proof states from client device(s).

Proof completion engine 304 is configured to complete the zero-knowledge proof generation for each corresponding proof delegation request based on the intermediate proof state corresponding to that request. As will be described in detail further below, in some embodiments, proof completion engine 304 uses at least a portion of the intermediate proof state related to a transaction to compute two additional sequential rounds of computations (the third and fourth rounds), whereby the intermediate proof state is input into the third round and the fourth round receives as input the output from the third round. In some embodiments, due to characteristics of the zero-knowledge proof protocol that is used in the proof delegation, the portion of the proof generation (e.g., the third and fourth rounds) at the prover system is of greater complexity than the portion of the proof generation that was precomputed at the client device. In that way, even though the proof is computed across the client device and the prover system, the prover system is required to perform computations of greater complexity and therefore use more computational resources/processing power to complete the proof than is utilized at the client device during the precomputation of the proof. After completing the third and fourth rounds of proof computation, proof completion engine 304 is configured to generate the full zero-knowledge proof based on at least a portion of the outputs from each of the first round, second round, third round, and fourth round of computation. The outputs from the first and second rounds of computation that are included in the full zero-knowledge proof were received from the client device.

Blockchain interface 306 is configured to send a full/completed zero-knowledge proof along with public information related to the relevant transaction to a blockchain network. The blockchain nodes would verify the proof before confirming the transaction. For example, confirming the transaction includes adding the output record(s) of the transaction to the ledger of the blockchain.

FIG. 4 is a diagram that describes a framework of a client device delegating a portion of the computation of a proof to be associated with a transaction to a single third-party prover in accordance with some embodiments. The framework described in FIG. 4 depicts that private (e.g., sensitive) input data associated with a requested transaction (e.g., the private account key of the transaction initiator, the public address of the recipient of the transaction, the contents of the input and/or output records of the transaction) that is received at the client device is also locally used to generate an intermediate proof state of a proof corresponding to the transaction. However, such private input data will not be passed from the client device to the third-party prover system. Rather, the third-party prover system is to only receive the intermediate proof state from the client device, which the prover system then uses with the functions associated with the transaction to compute the full proof that is to be associated with the transaction. The third-party prover system can then send the full proof to the blockchain over a network. The framework that is described in FIG. 4 reiterates that the prover system learns only of the functions related to the transaction but not the private input data, which allows for a secure proof delegation with minimal information transfer.

FIG. 5 is a flow diagram showing an embodiment of a process for delegating proof generation. In some embodiments, process 500 is implemented, at least in part, at client device 102 of FIG. 1.

At 502, a private input data and a public input data are received at a first processor to generate a computationally intensive proof associated with a transaction to be posted to a blockchain. The private input data and the public input data are parameters to an execute transaction that is requested at a client device. In various embodiments, the computationally intensive proof is zero-knowledge proof.

At 504, a first proof computation is executed at the first processor based at least in part on the private input data and the public input data to generate an intermediate proof state. In various embodiments, the zero-knowledge proof protocol that is used allows for the proof generation to be divided into two computations such that the first proof computation requires the private and public input data and the second proof computation takes in a portion of the output from the first proof computation but does not require the private and public input data. As a result, the first proof computation (or sometimes referred to as the “precomputation”) that is based on the private and public input data of the transaction can be computed by the first processor, which is local to the client device at which the private and public input data may be stored or obtained. The portion of the output of the first proof computation that is generated at the client device and that is sent over a network to a remote, second processor (that is associated with a prover system), is the “intermediate proof state.”

At 506, the intermediate proof state is sent to a second processor from an interface, wherein the second processor is configured to execute a second proof computation based at least in part on the intermediate proof state to generate the computationally intensive proof associated with the transaction, wherein it is computationally infeasible for the second processor to derive the private input data from the intermediate proof state. The intermediate proof state comprises data (e.g., challenges) that is ultimately generated from the private and public input data but yet cannot be used to recover the private input data. Put another way, the intermediate proof state is transaction-specific data to be used by the second processor to perform the second proof computation to generate the full proof. The prover system can then send the completed proof with public information of the transaction to a blockchain for recordation without ever being aware of the private input data of the transaction.

FIG. 6 is a flow diagram showing an example of a process for performing a first proof computation (precomputation) in accordance with some embodiments. In some embodiments, process 600 is implemented, at least in part, at client device 102 of FIG. 1. In some embodiments, steps 502 and 504 of process 500 of FIG. 5 may be implemented using process 600 of FIG. 6.

At 602, a request to initiate a transaction is received. In various embodiments, the requested transaction comprises an execute transaction. An example of an execute transaction is the transfer of tokens from one account (e.g., of the user that had initiated the transaction) to another.

At 604, public input data and private input data associated with the transaction are received. In some embodiments, at least some of the public input data and private input data associated with the transaction can be input by the user that had initiated the transaction. In some embodiments, at least some of the public input data and private input data associated with the transaction can be locally stored on the client device at which the transaction was initiated. In some embodiments, at least some of the public input data and private input data associated with the transaction can be queried by the client device at which the transaction was initiated. The designation of a piece of data as being either public or private can be configurable by the user at the client device. Examples of private input data include the private account key of the transaction initiator, the public address of the recipient of the transaction, the contents of the input and/or output records of the transaction. Examples of public input data include identifying information associated with the blockchain and identifying information associated with the functions to be executed for the transaction.

At 606, a first proof computation of a zero-knowledge proof corresponding to the transaction is executed based at least in part on the public input data, the private input data, and a set of functions associated with the transaction, wherein the execution of the first proof computation produces an intermediate proof state, wherein the private input data cannot be recovered from the intermediate proof state. In various embodiments, a sequence of multiple rounds of computations are needed to be performed in the zero-knowledge proof protocol. The initial round of computations takes in the public input data and the private input data of the transaction as input, and then each subsequent round takes at least a portion of the output from the previous round as input. In some embodiments, the initial two rounds of the sequence of rounds of computations are locally computed at the client device in the first proof computation (precomputation) to generate the intermediate proof state. The intermediate proof state comprises a portion of the output of the first and second rounds of computation that are performed at the client device and is sent from the client device, over a network, to a remote prover system. The advantage of sending the intermediate proof state to the remote prover system is that the prover system can complete the zero-knowledge proof on the intermediate proof state without ever needing the private input data from which the intermediate proof state was derived. Put another way, the private input data does not leave the client device in the process of proof delegation.

FIG. 7 is a flow diagram showing an example of a process for performing a first proof computation (precomputation) in accordance with some embodiments. In some embodiments, process 700 is implemented, at least in part, at client device 102 of FIG. 1. In some embodiments, step 606 of process 600 of FIG. 6 may be implemented using process 700 of FIG. 7.

At 702, a set of functions associated with a transaction is synthesized into function-related arithmetic circuits. In the specific example of a token transfer transaction, three types of functions could be executed. The first function is to perform the token transfer from a sender account to a recipient account. The second function is to check that the input value of tokens of the transfer equals the output value of tokens. The third function is to check that the input tokens that are to be sent by the sender account have been previously transferred to/belong to the sender account. In various embodiments, a function comprises a mathematical function that describes the logic of constraints to enforce and is implemented by a segment of high-level computer code. For instance, the second function that checks that the input value of tokens of the transfer equals the output value of tokens can be implemented by computer code that adds up the tokens included in all the input records, adds up the tokens included in all the output records, and then checks whether the total input tokens equal the total output tokens.

As mentioned above, in some embodiments, the set of functions that are to be executed for the transaction are implemented as high-level computer code. However, the compiler that computes the zero-knowledge proof does not understand the high-level computer code and so the functions need to be synthesized into arithmetic circuits, which are a low-level representation of the functions that can be understood by the compiler.

At 704, public input data are private input data associated with the transaction are formatted into witness assignments. Each function includes its own private and/or public inputs. For instance, the third function that checks whether the input tokens that are to be sent by the sender account actually belong to the sender account may take as a public input of a Merkle tree root (where the Merkle tree was generated from the posted transactions to the blockchain) and a private input of a Merkle tree path for the input record in the blockchain that is to be transferred/spent in the transaction. The function will confirm that the private input Merkle tree path is in fact associated with an input record that belongs to the sender account.

While the private and public input data to each function are high-level values, they are formatted into witness assignments, which is a low-level representation of the values so that they can be understood by the function-related arithmetic circuits.

At 706, a first round of computation comprising matrix multiplication between the function-related arithmetic circuits and the witness assignments are performed to generate a set of matrix multiplication products. In some embodiments, the witness assignments comprise vectors and each function-related arithmetic circuit comprises a matrix. In the first round of computation of the selected zero-knowledge proof protocol, the function-related arithmetic circuits/matrices are multiplied against the witness assignment vectors to obtain matrix vector products.

At 708, a first set of polynomials is derived from the set of multiplication products using polynomial interpolation. A first set of polynomials representations are determined from the matrix vector products using polynomial interpolation. Each polynomial representation comprises the interpolation of a corresponding matrix vector product and is the polynomial of the lowest possible degree that passes through the pairs of values of the vector. In some embodiments, an additional random polynomial that is sampled for randomness is also generated in the first round of computation.

At 710, a first set of commitments derived from the first set of polynomials are sent to a prover system. The polynomials that are generated from the first round of computation contain information about the witness assignments, which includes the private input data, and so to prevent the leakage of the private input data, the polynomials cannot be directly sent over to the prover system. Instead of sending the polynomials themselves, commitments that are derived from the polynomials (polynomial commitments) using a protocol such as Kate-Zaverucha-Goldberg (KZG), for example. A polynomial commitment is a short representation of the polynomial, similar to the hash of a value. For instance, a polynomial could have millions of coefficients but its KZG commitment could be only 32 or 48 bytes. In various embodiments, while a polynomial commitment is derived from a polynomial, the polynomial commitment cannot be used to recover the polynomial itself.

At 712, a second round of computation is performed based at least in part on the first set of polynomials to confirm that the first set of polynomials are derived from the witness assignments and to generate a second set of polynomials and a set of challenges. The second round of computations is performed to further confirm (to an eventual verifier of the proof) that the first set of polynomials are derived from the witness assignments. Execution of the second round of computations results in a second set of polynomials and a set of challenges. In some embodiments, the set of challenges are random values that are derived during the process of the zero-knowledge proof protocol execution.

At 714, the set of challenges, a second set of commitments, and a first evaluation proof derived from the second set of polynomials are sent to the prover system. Polynomial commitments (similar to how commitments were derived from the first set of polynomials from the first round) and a corresponding evaluation proof are derived from the second set of polynomials (e.g., using the KZG protocol) and then sent along with the set of challenges to the prover system. The evaluation proof corresponding to the polynomial commitments of the second round of computation comprises a way for the proof constructor to convince an eventual verifier that each committed polynomial, when evaluated at the given point evaluates to the claimed evaluations. In some embodiments, both polynomial commitments and the corresponding evaluation proof are elliptic curve elements.

To summarize, in some embodiments, the first set of polynomial commitments, the second set of polynomial commitments, the first evaluation proof, and the set of challenges form the “intermediate proof state” that is sent from the client device to the prover system so that the prover system can complete the zero-knowledge proof. Because none of components of the intermediate proof state can be used to recover the private input data, the data privacy of the private input data is secured.

FIG. 8 is a flow diagram showing an example of a process for performing a second proof computation in accordance with some embodiments. In some embodiments, process 800 is implemented, at least in part, at prover system 104 of FIG. 1.

At 802, a first set of commitments, a second set of commitments, a first evaluation proof, and a set of challenges associated with a requested transaction are received from a client device, wherein private input data to the transaction cannot be recovered from one or more of the set of commitments, the second set of commitments, the first evaluation proof, and the set of challenges. As mentioned above, the first set of commitments, the second set of commitments, the first evaluation proof, and the set of challenges are produced by the client device from performing the first proof computation (precomputation) of the zero-knowledge proof corresponding to the transaction (e.g., using a process such as process 700 of FIG. 7). For example, the first set of commitments, the second set of commitments, the first evaluation proof, and the set of challenges were sent from the client device with a proof delegation request to complete generation of the proof for the transaction.

At 804, a set of functions associated with the requested transaction is determined. The set of functions that are associated with the transaction can be identified in the proof delegation request, for example.

At 806, a third round of computation is performed based at least part on the set of functions and the set of challenges to generate a third set of polynomials and a claimed sum. In some embodiments, polynomials are derived from the matrices that represent the functions. These polynomials are derived from the matrices that are specific to the functions but are generic to all transactions that use those functions. The set of challenges that is received from the client device is specific to the transaction but cannot be used to recover the private input data to the transaction. In some embodiments, polynomial interpolation is used to generate a polynomial corresponding to each matrix that is derived from a distinct function that is to be executed for the transaction. These polynomials that are derived from function-related matrices are the “third set of polynomials.” This third set of polynomials and the set of challenges are then used to determine the “claimed sum.” In some embodiments, the claimed sum that is output by round three is the evaluation of the each of the polynomials in the third set at each of the challenge values data points (that were received from the client device). The claimed sum is the sum of the evaluation of each of the polynomials in the third set at each of the challenge values.

At 808, a third set of commitments are derived from the third set of polynomials. As mentioned above, polynomial commitments (“the third set of commitments”) can be derived from the third set of polynomials using the KZG protocol.

At 810, a fourth round of computation is performed based at least in part on the third set of polynomials to generate a fourth set of polynomials.

At 812, a fourth set of commitments and a second evaluation proof are derived from the third set of polynomials.

FIG. 9 is a flow diagram showing an example of a process for completing a full proof in accordance with some embodiments. In some embodiments, process 900 is implemented, at least in part, at prover system 104 of FIG. 1.

At 902, a full zero-knowledge proof corresponding to a transaction is generated based at least in part on respective sets of commitments and evaluation proofs corresponding to a plurality rounds of computations that have been performed across a client device and a prover system. In some embodiments, the respective polynomial commitments and evaluation proofs that were produced by the four rounds of computations are used to construct the zero-knowledge proof corresponding to the transaction. As described above, in some embodiments, the first two rounds (which makes up the “private” portion of the zero-knowledge proof protocol) are first computed by the client device and the last two rounds (which makes up the “public” portion of the zero-knowledge proof protocol) are then delegated to and computed by the prover system.

At 904, the full zero-knowledge proof is sent along with other public transaction information to a blockchain, wherein the blockchain is configured to confirm the transaction based at least in part on the full zero-knowledge proof. The completed zero-knowledge proof is then sent with public information related to the transaction to a blockchain. For example, the node(s) of the blockchain will confirm/verify the proof before they confirm the transaction (e.g., by adding the output records of the transaction to the ledger). Examples of public information include the root of the Merkle tree that was generated from the blockchain and the serial numbers of the input records.

In some other embodiments, instead of the prover system constructing the full zero-knowledge proof based on the polynomial commitments and evaluation proof(s) corresponding to the four rounds of computations, the prover system sends the polynomial commitments and evaluation proof(s) that are produced from the rounds (the third and fourth rounds) that it had computed to the client device. The client device would then have the polynomial commitments and evaluation proofs corresponding to all four rounds and could then construct the full zero-knowledge proof locally. The client device would then send the constructed zero-knowledge proof and the public information related to the transaction to the blockchain.

FIG. 10 shows a high-level description of a client device delegating a portion of proof computation to a single prover in accordance with some embodiments. The requested transaction for which a zero-knowledge is to be computed can be multiple functions, including one or more instances of the same type of function (e.g., three instances of function type 1, two instances of function type 2, and a single instance of function type 3) and/or also instances of distinct function types (e.g., one instance of function type 1, one instance of function type 2, and one instance of function type 3). As shown in FIG. 10, the client device takes as input the public input data, the private input data, and the functions associated with the transaction. The private input data (e.g., sensitive user data) can be locally stored at the client device and in accordance with various embodiments described herein, will not be passed along to the prover system during the process of delegation so as to avoid a leak of private information. As such, in the delegation system described herein, the private input data is only used during the precomputation of the proof at the client device and is not passed thereafter to another entity (e.g., the prover). Rather, the precomputation at the client device results in an intermediate proof state, which comprises values that cannot be used to recover the private input data. In various embodiments, the prover system that receives the intermediate proof state associated with the transaction has an awareness of the functions to be used to complete the proof for the transaction. For example, the functions associated with the transaction can be queried from the blockchain on which the functions of the transaction were previously deployed. The prover system then completes the remaining portion of the proof computation based on the functions of the transaction and the intermediate proof state.

The intermediate proof state of the proof that is generated by the client device and the second portion of the proof that is generated by the prover system can be combined to result in the full proof that is to be sent to a blockchain over a network.

The computational complexity of the first proof computation/precomputation by the client device can be described as O(n log n) and O(n), where n=the number of constraints, which is the number of constraints in the arithmetization of the function-related circuits as matrices. The computational complexity of the second proof computation by the prover can be described as O(m log m) and O(m), where m=the number of non-zero entries, which is the number of terms in that represent in the arithmetization of the function-related circuits as matrices. Empirical observation of the computation of a zero-knowledge proof using a protocol like the Marlin protocol is that m>n and that as a result, the portion of the second proof computation is more complex (e.g., more computationally expensive) at the prover system than the first proof computation/precomputation at the client device. Such a protocol therefore offloads the computational-heavy task of completing the full proof from the client device, which has comparatively less robust hardware than the prover system.

FIG. 11 is a sequence diagram showing an example process of deleting proof generation from a client device to a prover system in accordance with some embodiments. In some embodiments, process 700 of FIG. 7 and process 800 of FIG. 8 can be implemented, at least in part, using process 1100 of FIG. 11.

The steps of process 1100 are described with sample mathematical descriptions from the Marlin zero-knowledge proof protocol.

At 1102, round 1 and round 2 of a zero-knowledge proof (zkp) protocol are computed at a client device based on public input data, private input data, and functions associated with a transaction.

At 1104, round 1 commitments, round 2 commitments, round 2 evaluation proof, and a set of challenges are generated at the client device and sent to the prover system.

### Compute Round 1

$${z}_{i , j} := ( {x}_{i , j} , {w}_{i , j} ) , {z}_{A , i , j} := {A}_{{iZ}_{i , j}} , {z}_{B , i , j} := {B}_{{iZ}_{i , j}} \\ sample {\hat{w}}_{i , j} ( X ) ∈ {𝔽}^{< \vert {w}_{i , j} \vert + b} [ X ] and {\hat{z}}_{A , i , j} ( X ) , {\hat{z}}_{B , i , j} ( X ) ∈ {𝔽}^{< \vert {H}_{i} \vert + b} [ X ]$$

sample mask polynomial m(X)∈ [symbol] ^{<3|H|+2b-2}[X] such that [symbol] m( [symbol] )=0

As shown in the mathematical description above, in round 1, the private input data (w_{i,j}) and public input data (x_{i,j}) are formatted into a vector of witness assignments (z_{i,j}). The vector of witness assignments are multiplied with matrices (A and B) that are arithmetic circuit representations of a function associated with the transaction. Polynomials (e.g., ŵ_{i,j}, \hat{z}_{A,i,j}, and \hat{Z}_{B,i,j}) are generated from the matrix vector products using polynomial interpolation. For example, there are as many polynomials that are generated as there were instances of function execution. Additionally, a random polynomial (m) is also generated for randomness.

### Round 1 Commitments to Send to the Prover System

Commitments {cm_{ŵ}_{_{i,j}}}, {cm_{\hat{z}}_{_{A,i,j}}}, {cm_{\hat{z}B,i,j}}, cmₘ

As shown above, polynomial commitments are derived from the polynomials produced in round 1 (e.g., using the KZG protocol).

### Compute Round 2

$${η}_{A} , {η}_{B} , {η}_{C} ← 𝔽 \\ α ← 𝔽 \backslash H \\ \{ {v}_{i} \} , \{ {τ}_{i , j} \} ← 𝔽 \\ Compute {t}_{i} ( X ) := {\sum }_{M ∈ \{ {A}_{i} , {B}_{i} , {C}_{i} \}} {η}_{M} {τ}_{M} ( α , X ) and \\ {\hat{z}}_{i} ( X ) := {\sum }_{j} {τ}_{i , j} ( {\hat{w}}_{i , j} ( X ) {v}_{{H}_{i} [ \leq \vert {x}_{i , j} \vert ]} ( X ) + {\hat{x}}_{i , j} ( X ) ) \\ Sum check for m ( X ) + {\sum }_{i ∈ [ \vert 𝒟 \vert ]} {v}_{i} {𝓈}_{{H}_{i} {H}_{2}} ( X ) ( {u}_{{H}_{i}} ( α , X ) {\sum }_{j ∈ \vert {𝒟}_{i} \vert} {τ}_{i , j} {\sum }_{M} {\hat{z}}_{M , i , j} ( X ) - {t}_{i} ( X ) {\hat{z}}_{i} ( X ) ) = 0 over H \\ Let {\hat{z}}_{C , i} ( X ) := {\hat{z}}_{A , i} ( X ) \cdot {\hat{z}}_{B , i} ( X ) \\ Find {g}_{1} ( X ) ∈ {𝔽}^{\vert H \vert - 1} [ X ] and {h}_{1} ( X ) such that \\ m ( X ) + {\sum }_{i ∈ [ \vert 𝒟 \vert ]} {v}_{i} {𝓈}_{{H}_{i} {H}_{2}} ( X ) ( {u}_{{H}_{i}} ( α , X ) {\sum }_{j ∈ \vert {𝒟}_{i} \vert} {τ}_{i , j} {\sum }_{M} {η}_{M} {\hat{z}}_{M , i , j} ( X ) - {t}_{i} ( X ) {\hat{z}}_{i} ( X ) ) = {h}_{1} ( X ) {v}_{H} ( X ) + {Xg}_{1} ( X ) \\ \begin{matrix}{ξ}_{1} , … , {ξ}_{\vert Q \vert} ← F & {v}_{{g}_{1} :=} {g}_{1} ( β ) , \{ {v}_{{\hat{z}}_{B , i}} := {\hat{z}}_{B , i} ( β ) \} & β ← 𝔽 \backslash H\end{matrix}$$

Use cmₘ, {cm_{\hat{z}}_{_{A,i,j}}}, {cm_{ŵ}_{_{i,j}}}, cmₕ_{₁}, evaluations {\hat{z}_{B,i,j}(β)}, g₁(β) and sums {σ_{M}} to construct virtual commitment vcmₗᵢₙ.

Use PC.Open with randomness ξ₁, . . . , ξ_{|Q|} to construct a batch opening proof π₁ of the following: (cm_{g}_{₁}, cm_{\hat{z}}_{_{B,i,j}}, vcmₗᵢₙ) at β evaluate to (v_{g}, v_{\hat{z}}_{_{B,i}}, 0).

As shown in the mathematical description above, in round 2, the polynomials generated by round 1 are used to generate additional polynomials (e.g., g₁ and h₁) and set of challenges (η_{A}, η_{B}, η_{C}, α, {vᵢ}, and {τ_{i,j}}).

In particular, the set of challenges are derived by hashing the commitments generated from round 1 (e.g., {cm_{ŵ}_{_{i,j}}}, {cm_{\hat{z}}_{_{A,i,j}}}, {cm_{\hat{z}}_{_{B,i,j}}}, cmₘ). While the commitments are derived in part from the witness assignments to round 1, the commitments do not reveal any private/sensitive data from the witness assignments and therefore, the hashes that are derived from the commitments also do not reveal any private/sensitive data from the witness assignments. As such, the set of challenges can be shared/send with the prover system without any leakage of sensitive data that might have been included in the witness assignments.

g₁ and h₁ are polynomials that can be used to convert the sum check claim described above to a polynomial equality claim, which is an easier type of claim to check.

g₁ and h₁ can be derived by dividing m(X)+ [symbol] (X)(u_{H}_{ᵢ} (α,X) [symbol] τ_{i,j} Σ_{M}η_{M}\hat{z}_{M,i,j}(X)−tᵢ(X)\hat{z}ᵢ(X)) (shown above) by the vanishing polynomial v_{H}.

### Round 2 Commitments and Challenges to Send to the Prover System

Commitments cm_{g}_{₁}, cmₕ_{₁}, α and β

As shown above, polynomial commitments (cm_{g}_{₁}, cmₕ_{₁}) are derived from the polynomials produced in round 2 (e.g., using the KZG protocol). Challenges α and β are derived from data that is specific to the transaction but appear random and cannot be used by the prover system to recover the private input data.

At 1106, round 3 and round 4 of the zkp protocol are computed at the prover system.

At 1108, round 3 commitments, round 4 commitments, and round 4 evaluation proof are generated at the prover system.

### Compute Round 3

$$For each M ∈ ℳ , sumcheck for \\ \frac{{v}_{{H}_{i}} ( β ) {v}_{{H}_{i}} ( α ) {val}_{M} * ( X )}{( β - {row}_{B} * ( X ) ) ( α - {col}_{M} * ( X ) )} over {K}_{M} \\ Let {a}_{M} ( X ) := {v}_{{H}_{i}} ( β ) {v}_{{H}_{i}} ( α ) {val}_{M} * ( X ) \\ \begin{matrix}Let {b}_{M} ( X ) := ( β - {row}_{M} * ( X ) ) ( α - {col}_{M} * ( X ) ) \\ = αβ - {αrow}_{M} * ( X ) - β {col}_{M} * ( X ) + {rowcol}_{M} * ( X ) ( over {K}_{M} )\end{matrix} \\ Find {g}_{M} ( X ) , {h}_{M} ( X ) ∈ {𝔽}^{\vert {K}_{M} \vert - 1} [ X ] and {σ}_{M} ∈ 𝔽 such that \\ {a}_{M} ( X ) - {b}_{M} ( X ) ( {Xg}_{M} ( X ) + \frac{{σ}_{M}}{\vert {K}_{M} \vert} ) = {h}_{M} ( X ) {v}_{{K}_{M}} ( X )$$

As shown in the mathematical description above, in round 3, a matrix polynomial (e.g., which is represented by the val_{M}*, row_{M}*, col_{M}*), is determined from the distinct types of functions related to the transaction, and the set of challenges (α and β) are used to determine polynomials (g_{A,i}, g_{B,i}, and g_{C,i}).

Rounds 3 and 4 collectively enable the efficient checking of the matrix vector products A_{z}, B_{z}, and C_{z} by reducing to a particular sum check claim. Polynomials g_{A,i}, g_{B,i}, and g_{C,i}) serve the same purpose as polynomial g₁ in round 2.

### Round 3 Commitments and Claimed Sum

Commitments {cm_{g}_{_{A,i}}}, {cm_{g}_{_{B,i}}}, {cm_{g}_{_{C,i}}} and claimed sums {σ_{M}}

As shown above, polynomial commitments (cm_{g}_{_{A,i}}, cm_{g}_{_{B,i}}, cm_{g}_{_{C,i}}), are derived from the polynomials produced in round 4 (e.g., using the KZG protocol). The claimed sum (σ_{M}) is the sum of the evaluation of the matrix polynomial at the data points comprising the challenges α and β.

### Compute Round 4

$$\{ {δ}_{A , i} \} , \{ {δ}_{B , i} \} , \{ {δ}_{C , i} \} ← 𝔽 \\ Let {h}_{2} ( X ) := {\sum }_{m ∈ ℳ} ( \frac{{δ}_{M} {𝓈}_{K , {K}_{M}} ( X ) {h}_{M} ( X ) \vert {K}_{M} \vert}{\vert K \vert} ) ( mod {v}_{K} )$$

As shown in the mathematical description above, in round 4, a polynomial (h₂) is derived from the polynomials produced in round 3.

### Round 4 Commitment

Commitments cmₕ_{₂}

As shown above, polynomial commitment (cmₕ_{₂}) is derived from the polynomial produced in round 4 (e.g., using the KZG protocol).

At 1110, the full zkp is generated by the prover system combining the round 1 commitments, the round 2 commitments, the round 3 commitments, the round 4 commitments, the round 2 evaluation proof, and the round 4 evaluation proof.

$$γ ← 𝔽 \\ \{ {v}_{{g}_{A , i}} := {g}_{A , i} ( γ ) \} , \{ {v}_{{g}_{B , i}} := {g}_{B , i} ( γ ) \} , \{ {v}_{{g}_{C , i}} := {g}_{C , i} ( γ ) \}$$

Use cmₕ_{₂}, and for each M∈ [symbol] , index commitments to row_{M}, col_{M}, rowcol_{M}, val_{M}, evaluation g_{M}(γ), and sum σ_{M} to construct virtual commitment vcmₘₐₜ.

ρ₁, . . . ,ρ_{|Q|}←

[symbol]

Use PC.Open with randomness ρ₁, . . . , ρ_{|Q|} to construct a batch opening proof π₂ of the following: (cm_{g}_{_{A,i}}, cm_{g}_{_{B,i}}, cm_{g}_{_{C,i}}, vcmₘₐₜ) at γ evaluate to (v_{g}_{_{A,i}}, v_{g}_{_{B,i}}, v_{g}_{_{C,i}}, 0).

### Compute and Combine Rounds 1, 2, 3, and 4 Commitments, Evaluation Proofs, and Evaluations to Generate Full Proof π

The full proof includes (e.g., an array comprising) the commitments from rounds 1, 2, 3, and 4, the evaluation proofs from rounds 2 and 4, and the evaluations from rounds 2 and 4. For example, the evaluations include those from round 2 (v_{g}_{₁}, v_{\hat{z}}_{_{B,i}}) and round 4 (v_{g}_{_{A,i}}, v_{g}_{_{B,i}}, v_{g}_{_{C,i}}).

At 1112, the full zkp and public information of the transaction are sent by the prover system to a blockchain.

In some embodiments, to complete the computation of the full proof, either the client device or the prover system can use the commitments and evaluation proofs from the four rounds to construct the full proof. Whichever of the client device or the prover system can be designated by the configuration of the delegation process to use the commitments and evaluation proofs from the four rounds to construct the full proof. In some embodiments, one of the client device or the prover can be selected to construct the full proof based on one or more factors such as, for example, the amount of idle computation power and/or whether the entity is connected to a network. In some embodiments, the entity that constructs the full proof will send the full proof to the blockchain network, which can verify the associated transaction based on the proof before recording the output records on the ledger.

FIG. 12 is a sequence diagram showing an example process of verifying a proof in accordance with some embodiments. In some embodiments, process 1200 is implemented by a blockchain node or any party.

At 1202, a full zero-knowledge proof of a transaction is obtained. For example, the proof is generated by a process such as process 1100 of FIG. 11.

At 1204, whether the zero-knowledge proof can be verified is determined. In the event that the zero-knowledge proof can be verified, control is transferred to 1206. Otherwise, in the event that the zero-knowledge proof can be verified, control is transferred to 1208.

### Verify

verifier will need to check the following:

$$mat ( γ ) = {\sum }_{M ∈ ℳ} {δ}_{M} {𝓈}_{K , {K}_{M}} ( γ ) ( {a}_{M} ( γ ) - {b}_{M} ( γ ) ( γ {g}_{M} ( γ ) + \frac{{σ}_{M}}{\vert K \vert} ) ) - {h}_{2} ( γ ) {v}_{k} ( γ ) {=}^{?} 0$$

verifier will compute tᵢ

$$:= {\sum }_{M ∈ \{ {A}_{i} , {B}_{i} , {C}_{i} \}} \frac{{η}_{M} {σ}_{M}}{\vert K \vert} ,$$

and will need to check the following:

$$lin ( β ) = m ( β ) + {\sum }_{i ∈ [ \vert 𝒟 \vert ]} {v}_{i} {𝓈}_{H , {H}_{i}} ( β ) {\sum }_{j ∈ [ {𝒟}_{i} ]} {τ}_{i , j} ( {u}_{{H}_{i}} ( α , β ) {η}_{A} {\hat{z}}_{A , i , j} ( β ) +$$

$${u}_{{H}_{i}} ( α , β ) {η}_{B} {\hat{z}}_{B , i , j} ( β ) - {t}_{i} {v}_{{X}_{i}} ( β ) {\hat{w}}_{i , j} ( β ) +$$

$${u}_{{H}_{i}} ( α , β ) {η}_{C} {\hat{z}}_{B , i , j} ( β ) {\hat{z}}_{A , i , j} ( β ) - {t}_{i} {\hat{x}}_{i , j} ( β ) ) - {h}_{1} ( β ) {v}_{H} ( β ) - β {g}_{1} ( β ) {=}^{?} 0$$

Put another way, the verifier would use all the portions of full proof π (all commitments, all evaluation proofs, all evaluations) to check that the two polynomials derived from the sum checks in rounds 2 and 4 are equal.

At 1206, the transaction is confirmed. In some embodiments, if the proof can be verified by a blockchain node, then the transaction is confirmed and added to the blockchain. For example, if the transaction were a token transfer, then confirming such a transaction could include adding the output records (e.g., that document the spend/transfer of tokens) to the ledger that is the blockchain.

At 1208, confirmation of the transaction is denied. However, if the proof cannot be verified by a blockchain node, then the transaction is not confirmed and therefore not added to the blockchain. For example, if the transaction were a token transfer, then denying the confirmation of such a transaction could result in the output records of the transaction (e.g., that document the spend/transfer of tokens) not being added to the ledger that is the blockchain.

While the examples described above shows a proof computation scheme that involves four rounds, in other examples, the proof computation scheme may involve more or fewer rounds of computation.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a first processor configured to:
receive a private input data and a public input data to generate a computationally intensive proof associated with a transaction to be posted to a blockchain; and
execute a first proof computation based at least in part on the private input data and the public input data to generate an intermediate proof state;
an interface configured to send the intermediate proof state to a second processor, wherein the second processor is configured to execute a second proof computation based at least in part on the intermediate proof state to generate the computationally intensive proof associated with the transaction, wherein it is computationally infeasible for the second processor to derive the private input data from the intermediate proof state.

2. The system of claim 1, wherein the computationally intensive proof comprises a zero-knowledge proof.

3. The system of claim 2, wherein the zero-knowledge proof is generated based on the Marlin protocol.

4. The system of claim 1, wherein to execute the first proof computation comprises to:
synthesize a set of functions associated with the transaction into function-related arithmetic circuits; and
format the public input data and the private input data associated with the transaction into witness assignments.

5. The system of claim 4, wherein to execute the first proof computation further comprises to:
perform matrix multiplication between the function-related arithmetic circuits and the witness assignments to generate a set of matrix multiplication products; and
derive a first set of polynomials from the set of multiplication products using polynomial interpolation, wherein the intermediate proof state comprises a first set of commitments derived from the first set of polynomials.

6. The system of claim 5, wherein the first set of commitments are determined from the first set of polynomials using the Kate-Zaverucha-Goldberg (KZG) protocol.

7. The system of claim 5, wherein to execute the first proof computation further comprises to:
perform a second round of computation based at least in part on the first set of polynomials to confirm that the first set of polynomials are derived from the witness assignments and to generate a second set of polynomials and a set of challenges, wherein the intermediate proof state further comprises the set of challenges, a second set of commitments, and a first evaluation proof derived from the second set of polynomials.

8. The system of claim 1, wherein the second processor being configured to execute the second proof computation comprises to:
obtain a matrix polynomial based on a set of functions associated with the transaction;
determine a third set of polynomials based on the matrix polynomials and a set of challenges that is included in the intermediate proof state received from the first processor; and
derive a third set of commitments from the third set of polynomials.

9. The system of claim 8, wherein the second processor being configured to execute the second proof computation comprises to:
perform a fourth round of computation based at least in part on the third set of polynomials to generate a fourth set of polynomials; and
derive a fourth set of commitments and a second evaluation proof from the fourth set of polynomials.

10. The system of claim 9, wherein the intermediate proof state comprises a first set of commitments associated with a first round of computation, a second set of commitments associated with a second round of computation, and a first evaluation proof associated with the second round of computation, and wherein to generate the computationally intensive proof associated with the transaction comprises to combine the first set of commitments, the second set of commitments, the first evaluation proof, the third set of commitments, the fourth set of commitments, and the second evaluation proof.

11. The system of claim 1, wherein the first processor is configured to send the computationally intensive proof to the blockchain, wherein the blockchain is configured to verify the computationally intensive proof to confirm the transaction.

12. The system of claim 1, wherein the first proof computation is associated with less computational complexity than the second proof computation.

13. The system of claim 1, wherein the public input data comprises a root of a Merkle tree, wherein the Merkle tree is determined based on records of the blockchain.

14. A method, comprising:
receiving, at a first processor, a private input data and a public input data to generate a computationally intensive proof associated with a transaction to be posted to a blockchain; and
executing, at the first processor, a first proof computation based at least in part on the private input data and the public input data to generate an intermediate proof state;
sending, from the first processor, the intermediate proof state to a second processor, wherein the second processor is configured to execute a second proof computation based at least in part on the intermediate proof state to generate the computationally intensive proof associated with the transaction, wherein it is computationally infeasible for the second processor to derive the private input data from the intermediate proof state.

15. The method of claim 14, wherein executing the first proof computation comprises:
synthesizing a set of functions associated with the transaction into function-related arithmetic circuits; and
formatting the public input data and the private input data associated with the transaction into witness assignments.

16. The method of claim 15, wherein executing the first proof computation further comprises:
performing matrix multiplication between the function-related arithmetic circuits and the witness assignments to generate a set of matrix multiplication products; and
deriving a first set of polynomials from the set of multiplication products using polynomial interpolation, wherein the intermediate proof state comprises a first set of commitments derived from the first set of polynomials.

17. The method of claim 16, wherein executing the first proof computation further comprises:
performing a second round of computation based at least in part on the first set of polynomials to confirm that the first set of polynomials are derived from the witness assignments and to generate a second set of polynomials and a set of challenges, wherein the intermediate proof state further comprises the set of challenges, a second set of commitments, and a first evaluation proof derived from the second set of polynomials.

18. The method of claim 14, wherein the second processor being configured to execute the second proof computation comprises to:
obtain a matrix polynomial based on a set of functions associated with the transaction;
determine a third set of polynomials based on the matrix polynomials and a set of challenges that is included in the intermediate proof state received from the first processor; and
derive a third set of commitments from the third set of polynomials.

19. The method of claim 18, wherein the second processor being configured to execute the second proof computation comprises to:
perform a fourth round of computation based at least in part on the third set of polynomials to generate a fourth set of polynomials; and
derive a fourth set of commitments and a second evaluation proof from the fourth set of polynomials.

20. The method of claim 19, wherein the intermediate proof state comprises a first set of commitments associated with a first round of computation, a second set of commitments associated with a second round of computation, and a first evaluation proof associated with the second round of computation, and wherein to generate the computationally intensive proof associated with the transaction comprises to combine the first set of commitments, the second set of commitments, the first evaluation proof, the third set of commitments, the fourth set of commitments, and the second evaluation proof.
